(19) United States
(12) Patent Application Publication
(10) Pub. No.: US 2026/0282181 A1
(43) Pub. Date: Sep. 17, 2026

(54) ANTENNA DRIVE MECHANISM AND MICROWAVE HEATING DEVICE

(71) Applicant: Panasonic Intellectual Property Management Co., Ltd., Osaka (JP)

(72) Inventors: Masayuki KUBO, Shiga (JP); Yoshiharu OOMORI, Shiga (JP)

(21) Appl. No.: 19/168,975

(22) PCT Filed: Jan. 31, 2024
(86) PCT No.: PCT/JP2024/003027

§ 371 Date: Sep. 25, 2025

(30) Foreign Application Priority Data
Apr. 25, 2023 (JP) 2023-071536

(51) Int. Cl. H05B 6/72; H05B 6/64

(52) U.S. Cl. CPC H05B 6/725; H05B 6/6411

(57) ABSTRACT

An antenna drive mechanism includes an antenna shaft that supports a rotating antenna; a motor shaft that is rotationally driven in a first rotation direction or a second rotation direction; a first rotation restriction, and a second rotation restriction, wherein in a state where rotation restriction by the first rotation restriction part is exerted, the antenna shaft relatively moves along an axial direction from a first position where the rotation restriction is exerted to a second position where the rotation restriction is released, in response to rotation of the motor shaft in the first rotation direction, and in a state where rotation restriction by the second rotation restriction part is exerted, the antenna shaft relatively moves along the axial direction from the second position where the rotation restriction is exerted to the first position where the rotation restriction is released, in response to rotation of the motor shaft in the second rotation direction.

### TECHNICAL FIELD

The present disclosure relates to an antenna drive mechanism that drives a rotating antenna and a microwave heating device including the antenna drive mechanism.

### BACKGROUND ART

Conventionally, there has been known a microwave heating device in which an object to be heated such as food is accommodated in a heating chamber, and microwaves are supplied to the inside of the heating chamber to heat and cook the object to be heated (See, for example, Patent Document 1).

The microwave heating device of Patent Document 1 includes a rotating antenna for supplying microwaves to a heating chamber, an antenna rotating motor that rotates the rotating antenna, and an antenna up and down drive motor that moves the rotating antenna up and down.

### PRIOR ART DOCUMENT

### Patent Document

Patent Document 1: JP-B2-4024145

### SUMMARY OF THE INVENTION

### Problems to be Solved by the Invention

In the microwave heating device of Patent Document 1, a motor is required for each of a rotation function and an up and down movement function of the rotating antenna, and the device tends to be enlarged. It can be said that there is room for improvement in achieving both high functionality and miniaturization of the microwave heating device.

Therefore, an object of the present disclosure is to solve the above problem, and to provide an antenna drive mechanism capable of achieving both high functionality and miniaturization, and a microwave heating device including the antenna drive mechanism.

### Solutions to the Problems

In order to solve the problems, an antenna drive mechanism of this disclosure includes: an antenna shaft that supports a rotating antenna that supplies microwaves to a heating chamber; a motor shaft that is screwed into the antenna shaft, is rotatable integrally with the antenna shaft, and is rotationally driven in a first rotation direction or a second rotation direction; and a first rotation restriction part that selectively restricts rotation of the antenna shaft in the first rotation direction, and a second rotation restriction part that selectively restricts rotation of the antenna shaft in the second rotation direction, wherein in a state where rotation restriction by the first rotation restriction part is exerted, the antenna shaft relatively moves along an axial direction from a first position where the rotation restriction is exerted to a second position where the rotation restriction is released, in response to rotation of the motor shaft in the first rotation direction, and in a state where rotation restriction by the second rotation restriction part is exerted, the antenna shaft relatively moves along the axial direction from the second position where the rotation restriction is exerted to the first position where the rotation restriction is released, in response to rotation of the motor shaft in the second rotation direction.

Also, an antenna drive mechanism of this disclosure include: an antenna shaft that supports a rotating antenna that supplies microwaves to a heating chamber; a motor that applies a rotational driving force in a first rotation direction or a second rotation direction to the antenna shaft; a rotation restriction part that selectively restricts a rotation operation of the antenna shaft such that when the antenna shaft receives the rotational driving force in the first rotation direction, a position in an axial direction of the antenna shaft is disposed at a first position, and when the antenna shaft receives the rotational driving force in the second rotation direction, a position in the axial direction of the antenna shaft is disposed at a second position different from the first position; and a control unit that controls a rotation direction of the rotational driving force by the motor.

Also, a microwave heating device of this disclosure comprising: the antenna drive mechanism; the rotating antenna driven by the antenna drive mechanism; and the heating chamber to which the rotating antenna supplies microwaves.

### Effects of the Invention

According to the present disclosure, both high functionality and miniaturization can be achieved.

### BRIEF DESCRIPTION OF THE DRAWINGS

FIG. 1A is a schematic side view of a microwave heating device of an embodiment.

FIG. 1B is a schematic side view of the microwave heating device of the embodiment.

FIG. 2 is a schematic plan view of a rotating antenna of the embodiment.

FIG. 3A is a perspective view of an antenna drive mechanism of the embodiment.

FIG. 3B is a perspective view of the antenna drive mechanism of the embodiment.

FIG. 4 is an exploded perspective view of the antenna drive mechanism of the embodiment.

FIG. 5 is an exploded perspective view of the antenna drive mechanism of the embodiment.

FIG. 6 is a perspective view illustrating an antenna shaft and a motor screw of the embodiment.

FIG. 7 is an exploded perspective view of the antenna shaft of the embodiment.

FIG. 8 is an exploded perspective view of the antenna shaft of the embodiment.

FIG. 9 is a cross-sectional view schematically illustrating a cross section of the antenna shaft of the embodiment.

FIG. 10A is a cross-sectional view schematically illustrating a longitudinal cross section of a peripheral configuration of the antenna shaft of the embodiment (raised position).

FIG. 10B is a cross-sectional view schematically illustrating the longitudinal cross section of the peripheral configuration of the antenna shaft of the embodiment (lowered position).

FIG. 11 is a perspective view of a ring member of the embodiment.

FIG. 12 is a perspective view of the ring member of the embodiment.

FIG. 13 is a perspective view for explaining an operation in a case where a movable pin of the embodiment rotates in a first rotation direction when located at a lower stage.

FIG. 14 is a perspective view for explaining an operation in a case where the movable pin of the embodiment rotates in the first rotation direction when located at an upper stage.

FIG. 15 is a perspective view for explaining an operation in a case where the movable pin of the embodiment rotates in a second rotation direction when located at the upper stage.

FIG. 16 is a perspective view for explaining an operation in a case where the movable pin of the embodiment rotates in the second rotation direction when located at the lower stage.

### DETAILED DESCRIPTION

A first aspect of this disclosure provides an antenna drive mechanism comprising: an antenna shaft that supports a rotating antenna that supplies microwaves to a heating chamber; a motor shaft that is screwed into the antenna shaft, is rotatable integrally with the antenna shaft, and is rotationally driven in a first rotation direction or a second rotation direction; and a first rotation restriction part that selectively restricts rotation of the antenna shaft in the first rotation direction, and a second rotation restriction part that selectively restricts rotation of the antenna shaft in the second rotation direction, wherein in a state where rotation restriction by the first rotation restriction part is exerted, the antenna shaft relatively moves along an axial direction from a first position where the rotation restriction is exerted to a second position where the rotation restriction is released, in response to rotation of the motor shaft in the first rotation direction, and in a state where rotation restriction by the second rotation restriction part is exerted, the antenna shaft relatively moves along the axial direction from the second position where the rotation restriction is exerted to the first position where the rotation restriction is released, in response to rotation of the motor shaft in the second rotation direction.

A second aspect of this disclosure provides the antenna drive mechanism according to first aspect, further comprising a cover to face an outer periphery of the antenna shaft, wherein the first rotation restriction part and the second rotation restriction part are provided on an inner periphery of the cover.

A third aspect of this disclosure provides the antenna drive mechanism according to second aspect, further comprising a waveguide structure that transmits microwaves toward the rotating antenna, wherein the cover is attached to the waveguide structure.

A fourth aspect of this disclosure provides the antenna drive mechanism according to third aspect, wherein the cover includes: a first member that includes the first rotation restriction part and the second rotation restriction part and constitutes the inner periphery; and a second member that is attached to the waveguide structure with the first member attached inside.

A fifth aspect of this disclosure provides the antenna drive mechanism according to any one of second aspect to fourth aspect, wherein the antenna shaft includes a protrusion that protrudes in a lateral direction intersecting the axial direction, the first rotation restriction part includes a first restriction wall that receives the protrusion in the first rotation direction, and the second rotation restriction part includes a second restriction wall that receives the protrusion in the second rotation direction, and the first restriction wall and the second restriction wall have different positions in the axial direction.

A sixth aspect of this disclosure provides the antenna drive mechanism according to claim 5, wherein the first rotation restriction part is provided adjacent to the first restriction wall and includes a first slope whose height gradually increases along the second rotation direction, and the second rotation restriction part is provided adjacent to the second restriction wall and includes a second slope whose height gradually increases along the first rotation direction.

A seventh aspect of this disclosure provides the antenna drive mechanism according to fifth aspect or seventh aspect, wherein the antenna shaft further includes a first biasing member that biases the protrusion in a protrusion direction.

An eighth aspect of this disclosure provides the antenna drive mechanism according to eighth aspect, wherein the protrusion includes a first protrusion that protrudes to one side in the lateral direction and a second protrusion that protrudes to another side in the lateral direction, and the first biasing member biases the first protrusion and the second protrusion in respective protrusion directions.

A ninth aspect of this disclosure provides the antenna drive mechanism according to any one of first aspect to eighth aspect, wherein the antenna shaft includes a first shaft that is screwed into the motor shaft and a second shaft that is disposed outside the first shaft and is movable integrally with the first shaft, and the rotating antenna is attached to the second shaft.

A tenth aspect of this disclosure provides the antenna drive mechanism according to ninth aspect, further comprising a second biasing member that generates a biasing force in the axial direction between the first shaft and the second shaft.

An eleventh aspect of this disclosure provides the antenna drive mechanism according to ninth aspect or tenth aspect, wherein the first shaft is made of resin, and the second shaft is made of metal.

A twelfth aspect of this disclosure provides the antenna drive mechanism according to any one of ninth aspect to eleventh aspect, wherein the first shaft includes a protrusion that protrudes in a lateral direction intersecting the axial direction, and the second shaft includes a through hole that allows the protrusion to pass in the lateral direction.

A thirteenth aspect of this disclosure provides the antenna drive mechanism according to any one of first aspect to twelfth aspect, wherein the rotating antenna is located away from a wall part constituting the heating chamber when the antenna shaft is located at the first position, and comes into contact with the wall part when the antenna shaft is located at the second position.

A fourteenth aspect of this disclosure provides the antenna drive mechanism according to thirteenth aspect, wherein the wall part is a bottom wall part of the heating chamber.

A fifteenth aspect of this disclosure provides an antenna drive mechanism comprising: an antenna shaft that supports a rotating antenna that supplies microwaves to a heating chamber; a motor that applies a rotational driving force in a first rotation direction or a second rotation direction to the antenna shaft; a rotation restriction part that selectively restricts a rotation operation of the antenna shaft such that when the antenna shaft receives the rotational driving force in the first rotation direction, a position in an axial direction of the antenna shaft is disposed at a first position, and when the antenna shaft receives the rotational driving force in the second rotation direction, a position in the axial direction of the antenna shaft is disposed at a second position different from the first position; and a control unit that controls a rotation direction of the rotational driving force by the motor.

A sixteenth aspect of this disclosure provides a microwave heating device comprising: the antenna drive mechanism; the rotating antenna driven by the antenna drive mechanism; and the heating chamber to which the rotating antenna supplies microwaves.

### EMBODIMENT

Hereinafter, an exemplary embodiment of an antenna drive mechanism and a microwave heating device according to the present disclosure will be described with reference to the accompanying drawings. The present disclosure is not limited to the specific configurations of the following embodiment, and configurations based on similar technical ideas are included in the present disclosure.

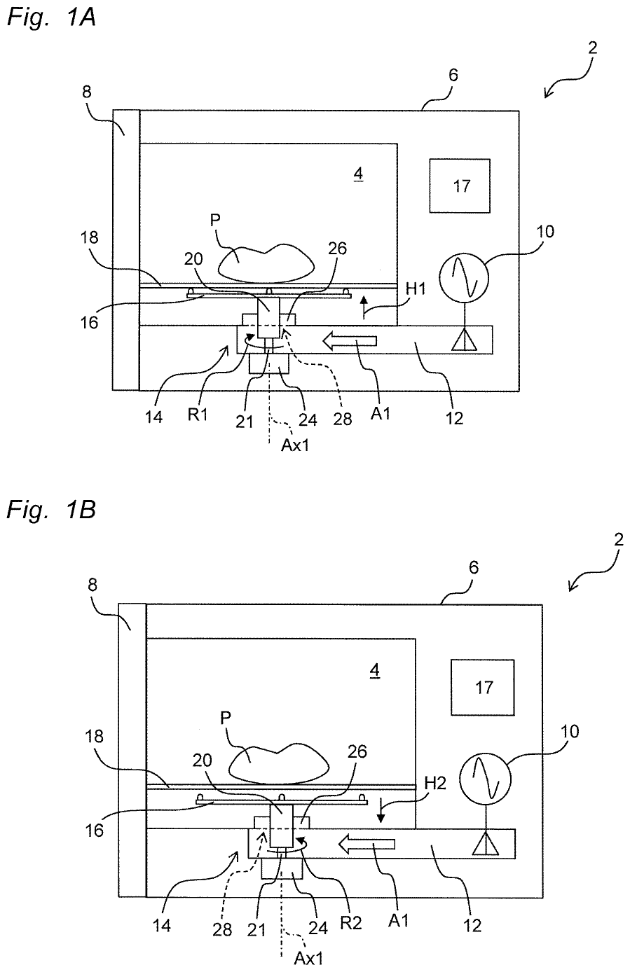

First, an antenna drive mechanism and a microwave heating device according to an embodiment of the present disclosure will be described with reference to FIGS. 1A and 1B.

FIGS. 1A and 1B are schematic side views of a microwave heating device 2 according to the embodiment.

The microwave heating device 2 illustrated in FIGS. 1A and 1B is cooking equipment (so-called a “microwave oven”) for heating and cooking an object P to be heated with microwaves. The object P to be heated may be any kind of food material.

As illustrated in FIGS. 1A and 1B, the microwave heating device 2 includes a casing 6 including a heating chamber 4, a door 8, a microwave generation device 10, a waveguide structure 12, an antenna drive mechanism 14, a rotating antenna 16, and a control unit 17.

The casing 6 is a member constituting an outer frame of the microwave heating device 2. As illustrated in FIGS. 1A and 1B, the casing 6 includes the heating chamber 4 inside, and is opened and closed by the door 8. The heating chamber 4 is a space for heating the object P to be heated, and includes a bottom wall part 18 on which the object P to be heated can be placed.

The microwave generation device 10, the waveguide structure 12, the antenna drive mechanism 14, the rotating antenna 16, and the control unit 17 are incorporated in the casing 6 outside the heating chamber 4.

The microwave generation device 10 is a device that generates microwaves, and generates microwaves having a frequency of 300 MHz to 300 GHz, for example. For example, a magnetron is used as the microwave generation device 10.

The waveguide structure 12 is a structure for supplying microwaves generated by the microwave generation device 10 to the heating chamber 4, and includes a waveguide capable of transmitting microwaves in a predetermined direction (see arrow A1). The antenna drive mechanism 14 and the rotating antenna 16 are connected to the waveguide structure 12.

The antenna drive mechanism 14 is a mechanism for driving the rotating antenna 16. The antenna drive mechanism 14 of the present embodiment has a function of rotating the rotating antenna 16 and a function of moving the rotating antenna 16 up and down.

The antenna drive mechanism 14 includes an antenna shaft 20 connected to the rotating antenna 16 and a motor 24 including a motor shaft 21 for transmitting a rotational driving force to the antenna shaft 20.

The antenna shaft 20 is a shaft that rotatably supports the rotating antenna 16, and rotates integrally with the rotating antenna 16 about a rotation axis Ax1. The rotation axis Ax1 extends in a height direction (that is, an up-down direction) of the microwave heating device 2. The antenna shaft 20 is inserted into a through hole 28 provided in the upper surface of the waveguide structure 12, and constitutes a coaxial structure together with the waveguide structure 12. A cover 26 is disposed around the antenna shaft 20.

The cover 26 is a member that covers the antenna shaft 20 from the outside in a movable state. The cover 26 is attached and fixed to the waveguide structure 12 together with the motor 24. The cover 26 of the present embodiment functions as a “rotation restriction part” that selectively restricts the rotation operation of the antenna shaft 20. By restricting the rotation operation of the antenna shaft 20, the antenna shaft 20 can be moved up and down.

The rotating antenna 16 is a member for supplying microwaves transmitted from the waveguide structure 12 toward the heating chamber 4. The rotating antenna 16 is rotatable about the rotation axis Ax1 together with the antenna shaft 20 described above.

The control unit 17 is a member that controls components of the microwave heating device 2, such as the microwave generation device 10 and the motor 24, and includes, for example, a microcomputer.

The antenna drive mechanism 14 including the antenna shaft 20 and the cover 26 raises the rotating antenna 16 (arrow H1) when rotating the antenna shaft 20 in the first rotation direction R1 as illustrated in FIG. 1A, and lowers the rotating antenna 16 (arrow H2) when rotating the antenna shaft 20 in the second rotation direction R2 as illustrated in FIG. 1B.

According to such an operation, the control unit 17 can move the rotating antenna 16 up and down toward a desired height position by controlling the direction of the rotational driving force with respect to the antenna shaft 20.

In the present embodiment, when the rotating antenna 16 is at the raised position as illustrated in FIG. 1A, the rotating antenna 16 is partially brought into contact with the bottom wall part 18 of the heating chamber 4 via a spacer described later. When the rotating antenna 16 is at the lowered position as illustrated in FIG. 1B, the rotating antenna 16 is disposed below and spaced apart from the bottom wall part 18 of the heating chamber 4 without being in contact with the bottom wall part 18.

By bringing the rotating antenna 16 into contact with the bottom wall part 18 of the heating chamber 4 via the spacer when the rotating antenna is at the raised position, a distance between the rotating antenna 16 and the object P to be heated can be easily kept constant, and a heating mode of the object P to be heated by microwaves can be stabilized.

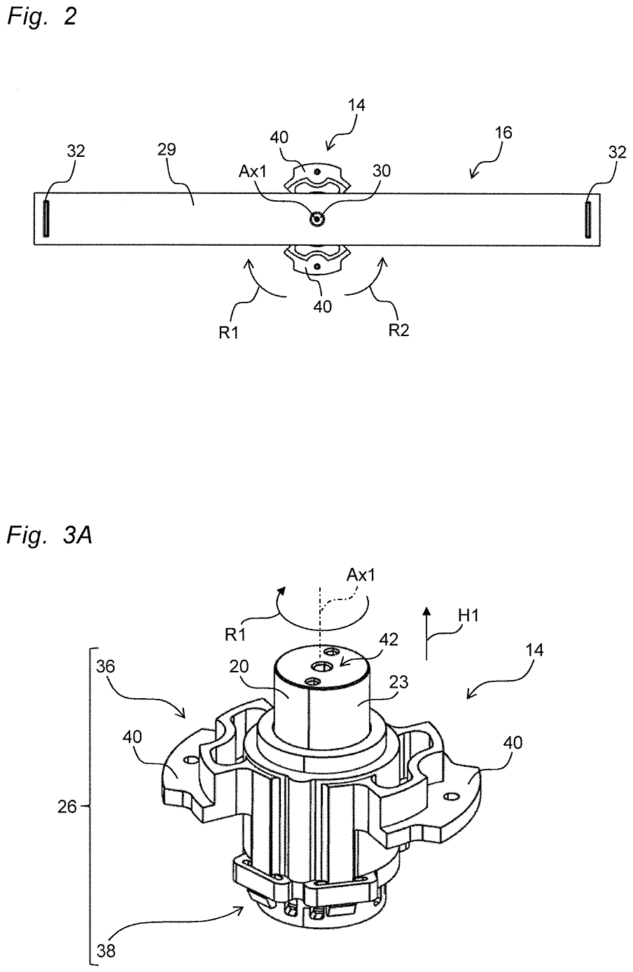

FIG. 2 is a schematic plan view of the rotating antenna 16.

The rotating antenna 16 illustrated in FIG. 2 may adopt any configuration as long as it can supply microwaves toward the heating chamber 4, and may supply microwaves such as radiated waves and surface waves in any form. In FIG. 2, the rotating antenna 16 is schematically illustrated.

As illustrated in FIG. 2, the rotating antenna 16 includes an upper surface 29, and includes a plurality of spacers 30 and 32 on the upper surface 29.

The spacers 30 and 32 are protrusions protruding upward from the upper surface 29 of the rotating antenna 16 toward the heating chamber 4. The spacers 30 and 32 function as spacers that contact the bottom wall part 18 of the heating chamber 4 to secure a distance between the bottom wall part 18 and the upper surface 29. The rotating antenna 16 is in contact with the bottom wall part 18 via the spacers 30 and 32. By providing the spacers 30 and 32, frictional resistance when the rotating antenna 16 rotates at the raised position illustrated in FIG. 1A can be reduced.

The spacer 30 is disposed at a center position of the upper surface 29 of the rotating antenna 16. The spacer 30 of the present embodiment overlaps the rotation axis Ax1 of the rotating antenna 16. A pair of the spacers 32 is disposed at both end portions of the upper surface 29 of the rotating antenna 16. The arrangement, shape, and number of the spacers 30 and 32 are not limited to the example illustrated in FIG. 2.

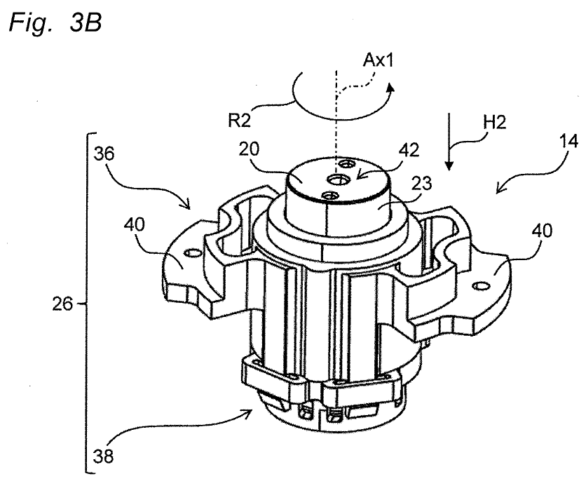

Hereinafter, the antenna drive mechanism 14 that drives the rotating antenna 16 will be described with reference to FIG. 3A and subsequent drawings.

FIGS. 3A and 3B are perspective views of the antenna drive mechanism 14. FIG. 3A illustrates a state (arrow H1) in which the antenna shaft 20 is in the raised position, and FIG. 3B illustrates a state (arrow H2) in which the antenna shaft 20 is in the lowered position.

As illustrated in FIGS. 3A and 3B, an attachment part 42 for attaching the rotating antenna 16 is provided at an upper end portion of the antenna shaft 20. In the example illustrated in FIGS. 3A and 3B, the attachment part 42 is a plurality of attachment holes.

As illustrated in FIGS. 3A and 3B, the cover 26 provided so as to surround an outer periphery 23 of the antenna shaft 20 includes an upper cover 36 and a lower cover 38.

The upper cover 36 and the lower cover 38 each have a through hole through which the antenna shaft 20 is inserted, and are connected to each other in the up-down direction. The upper cover 36 includes an attachment part 40 for attachment to the waveguide structure 12 illustrated in FIGS. 1A and 1B, and is attached and fixed to the waveguide structure 12 via the attachment part 40 and a fixing means (not illustrated) such as a screw. The lower cover 38 prevents the antenna shaft 20 from falling off while being attached to the upper cover 36.

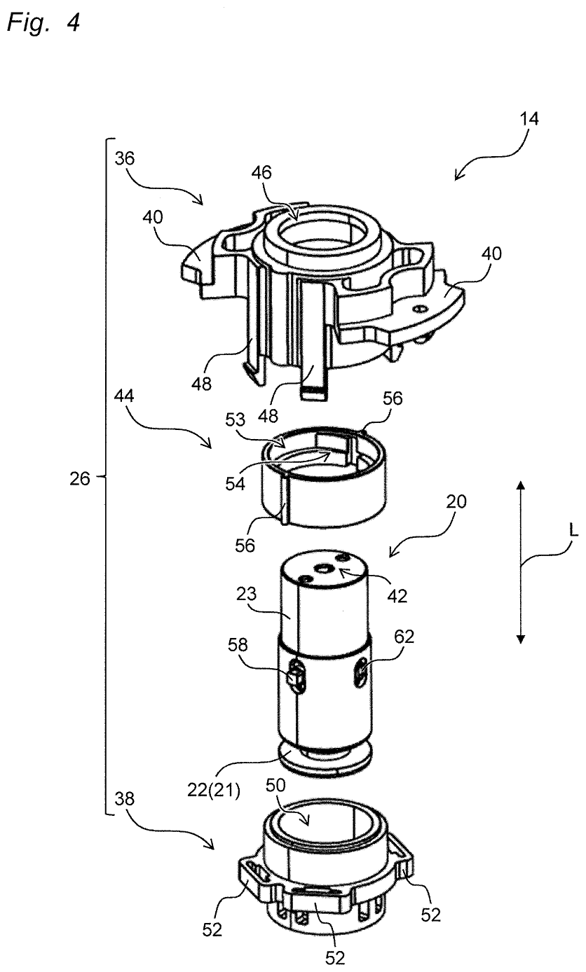

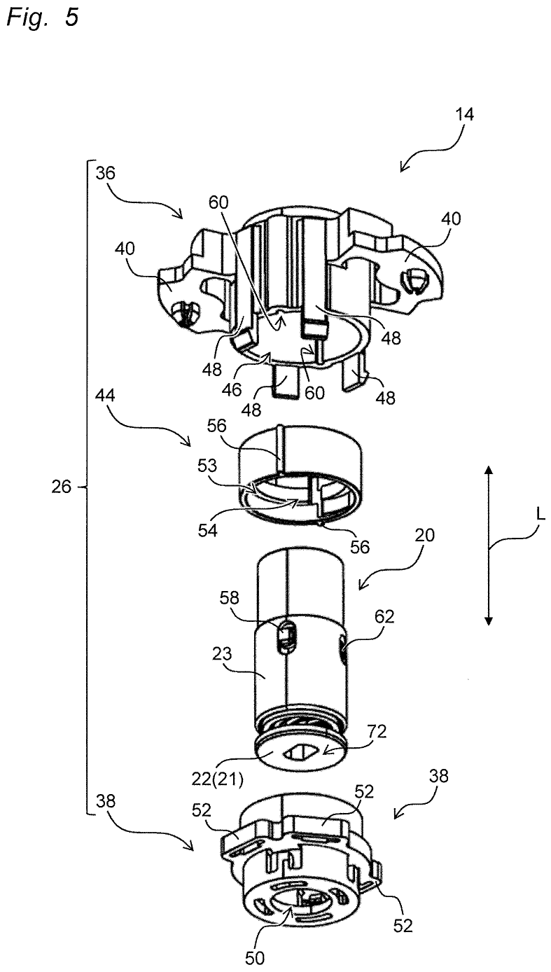

FIGS. 4 and 5 are exploded perspective views of the antenna drive mechanism 14.

As illustrated in FIGS. 4 and 5, the upper cover 36 includes a through hole 46 that accommodates the antenna shaft 20 so that it can move up and down, and an attachment claw 48 for attaching the lower cover 38. The lower cover 38 includes a through hole 50 that accommodates the antenna shaft 20 so that it can move up and down, and an insertion part 52 that inserts and engages the attachment claw 48 of the upper cover 36. The insertion part 52 includes an insertion hole for inserting the attachment claw 48.

The cover 26 further includes a ring member 44 in addition to the upper cover 36 and the lower cover 38.

The ring member 44 is an annular member including a rotation restriction part 54 for selectively restricting the rotation operation of the antenna shaft 20. The ring member 44 includes a through hole 53, and is sandwiched up and down and fixed by the upper cover 36 and the lower cover 38 in a state of being accommodated in the through hole 46 of the upper cover 36.

The ring member 44 of the present embodiment includes the rotation restriction part 54 on the inner periphery and a positioning part 56 on the outer periphery. The positioning part 56 is a protrusion extending in the up-down direction, and is disposed in a recess 60 provided in the inner periphery of the upper cover 36 illustrated in FIG. 5 to position the rotational position of the ring member 44.

The rotation restriction part 54 is selectively engaged with a movable pin 58 provided on the outer periphery 23 of the antenna shaft 20, and selectively restricts the rotation operation of the antenna shaft 20 according to the rotation direction of the antenna shaft 20. The rotation restriction part 54 of the present embodiment is formed in an uneven shape provided on the inner periphery of the ring member 44. Details of the rotation restriction part 54 will be described later.

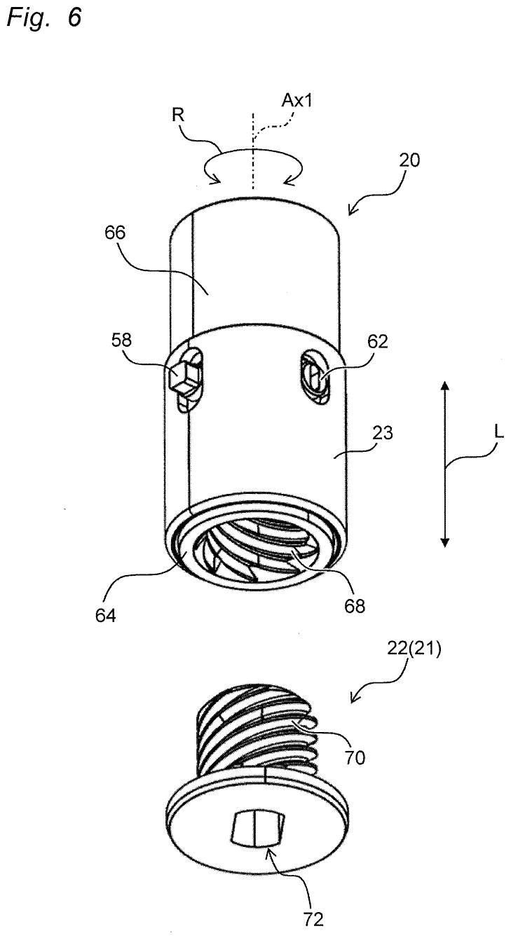

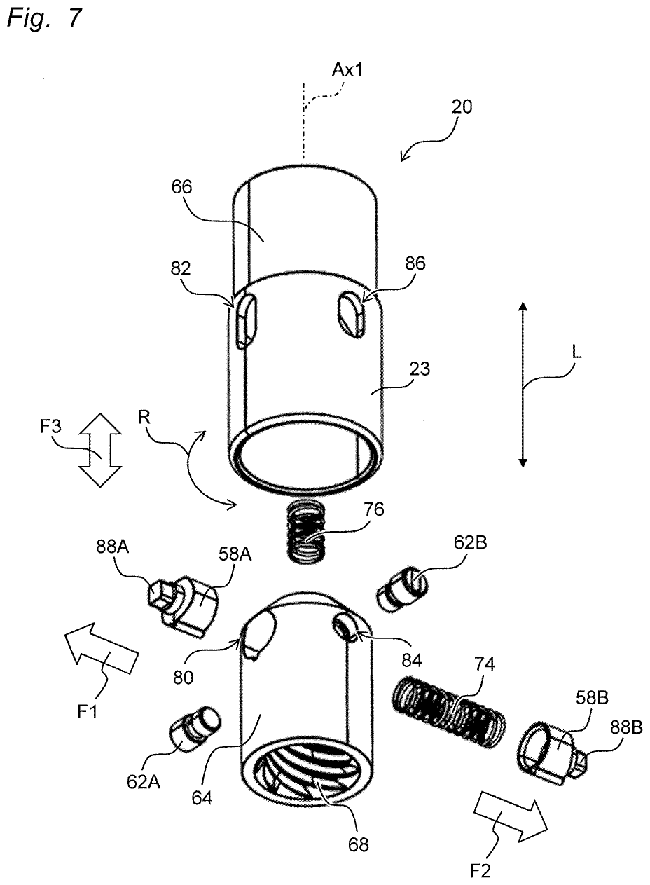

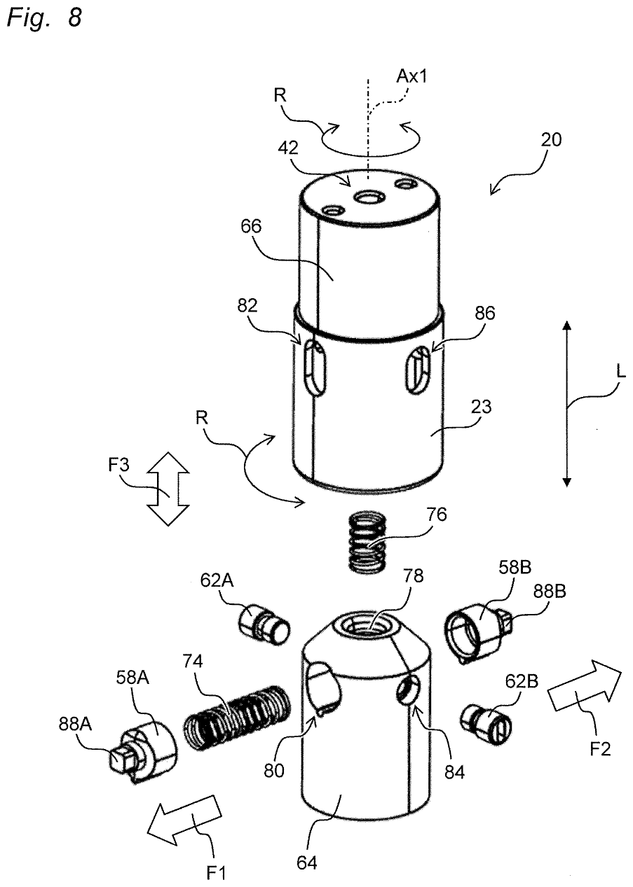

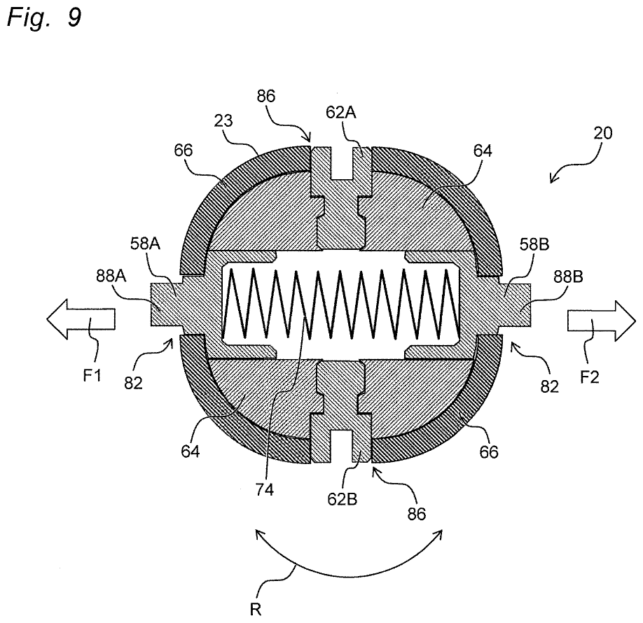

FIG. 6 is a perspective view illustrating the antenna shaft 20 and a motor screw 22. FIGS. 7 and 8 are each an exploded perspective view of the antenna shaft 20, and FIG. 9 is a cross-sectional view schematically illustrating a cross section of the antenna shaft 20.

As illustrated in FIGS. 6 to 8, the antenna shaft 20 includes an inner first shaft 64 and an outer second shaft 66. The first shaft 64 and the second shaft 66 are attached to each other so as to rotate integrally about the rotation axis Ax1. The motor screw 22 constituting the motor shaft 21 is connected to the first shaft 64.

As illustrated in FIG. 6, the first shaft 64 includes a screw part 68 on the inner periphery. The motor screw 22 connected to the first shaft 64 includes a screw part 70 on the outer periphery. By connecting the screw part 70 to the screw part 68, the antenna shaft 20 and the motor shaft 21 are screwed with each other and can be integrally rotated, and the rotational driving force by the motor 24 can be transmitted to the antenna shaft 20.

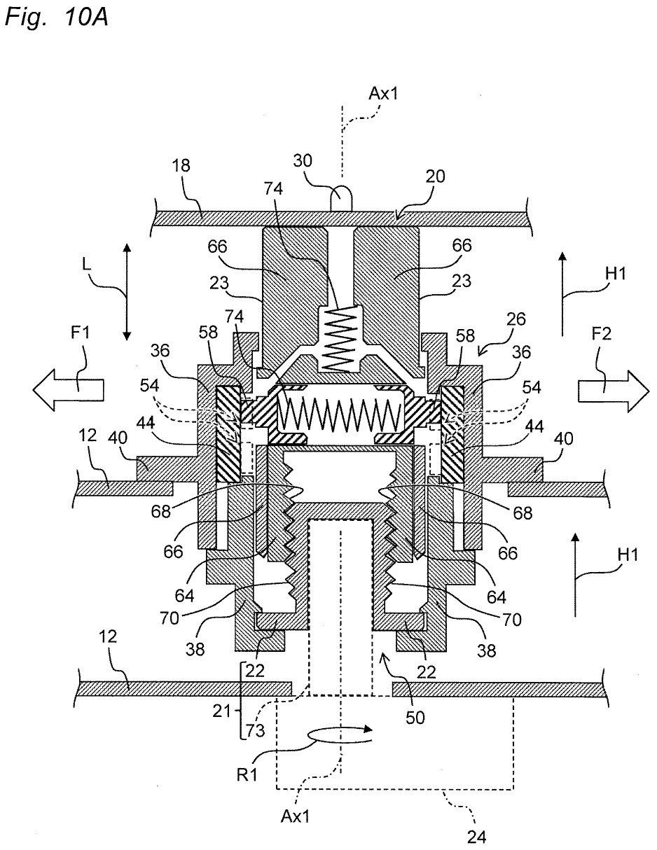

A lower surface of the motor screw 22 is provided with a connection hole 72. A rod-shaped coupling shaft 73 (FIG. 10A, FIG. 10B) extending from the motor 24 is inserted into the connection hole 72. The coupling shaft 73 has a cross-sectional shape different from a circular shape and rotates integrally with the motor screw 22. The motor shaft 21 includes the motor screw 22 and the coupling shaft 73.

While the antenna shaft 20 and the motor shaft 21 rotate integrally with each other in a state where the rotation restriction part 54 illustrated in FIGS. 4 and 5 does not restrict the rotation of the antenna shaft 20, only the motor shaft 21 rotates when the rotation restriction part 54 restricts the rotation of the antenna shaft 20. Since the vertical position of the motor shaft 21 is fixed, the antenna shaft 20 screwed into the motor shaft 21 relatively moves up and down along the axial direction L. Since the direction in which the antenna shaft 20 moves along the axial direction L changes according to the rotation direction of the motor shaft 21, the up and down movement of the antenna shaft 20 can be controlled.

As illustrated in FIGS. 7 and 8, the antenna shaft 20 includes, as members for connecting the first shaft 64 and the second shaft 66, a pair of movable pins 58A and 58B (movable pin 58), a pair of positioning pins 62A and 62B (positioning pin 62), a biasing member 74, and a biasing member 76.

The movable pins 58A and 58B are members that engage with the rotation restriction part 54 of the cover 26, and rotate integrally with the antenna shaft 20. The movable pins 58A and 58B may be collectively referred to as a “movable pin 58”. The positioning pin 62 and other members may be collectively referred to by a similar method.

The movable pins 58A and 58B are protrusions protruding outward in the radial direction (lateral direction) of the antenna shaft 20, and the movable pin 58A protrudes to one side and the movable pin 58B protrudes to the other side.

The movable pins 58A and 58B include engagement parts 88A and 88B, respectively. Each of the engagement parts 88A and 88B is a tip portion to be engaged with and come into contact with the rotation restriction part 54. In the engagement parts 88A and 88B of the present embodiment, the side surface in contact with the restriction wall of the rotation restriction part 54 has a linear shape.

The movable pins 58A and 58B are respectively inserted into a through hole 80 provided in the first shaft 64 and a through hole 82 provided in the second shaft 66.

The biasing member 74 is a member that biases the movable pins 58A and 58B in the respective protrusion directions (arrows F1 and F2). The biasing member 74 of the present embodiment is a compression spring having one end connected to the movable pin 58A and the other end connected to the movable pin 58B. The number of parts can be reduced by commonly biasing the two movable pins 58A and 58B with one biasing member 74.

The positioning pins 62A and 62B are members for determining relative rotational positions of the first shaft 64 and the second shaft 66. The positioning pins 62A and 62B are respectively inserted into a through hole 84 provided in the first shaft 64 and a through hole 86 provided in the second shaft 66. Since each of the through holes 84 and 86 extends by a predetermined length in a circumferential direction R around the rotation axis Ax1, the positioning pins 62A and 62B abut on the sides constituting the through holes 84 and 86, and the first shaft 64 and the second shaft 66 are positioned to each other in the circumferential direction R.

As illustrated in FIG. 9, the movable pins 58A and 58B are inserted into the through hole 82 of the second shaft 66, and a slight gap is provided between the movable pins and the side of the through hole 82 so as to be movable along the biasing direction (arrows F1 and F2) by the biasing member 74. By providing the positioning pins 62A and 62B separately from the movable pins 58A and 58B, positioning in the circumferential direction R is performed more accurately.

As illustrated in FIG. 9, the movable pins 58A and 58B are connected to each other via the biasing member 74, whereas the positioning pins 62A and 62B are not connected to each other and are provided independently. Thus, the movable pins 58A and 58B and the positioning pins 62A and 62B can be provided at the same height position (the same cross section) in the axial direction L of the antenna shaft 20.

The biasing member 76 illustrated in FIGS. 7 and 8 biases the inner first shaft 64 and the outer second shaft 66 to each other along the axial direction L. The biasing member 76 is disposed in a recess 78 provided in the upper surface of the first shaft 64 illustrated in FIG. 8, and biases the upper surface portion of the second shaft 66 and the upper surface portion of the first shaft 64 in directions away from each other (arrow F3). By providing the biasing member 76, a buffering action can be generated when the antenna shaft 20 rises and the rotating antenna 16 comes into contact with the bottom wall part 18. The biasing member 76 is, for example, a compression spring.

In the antenna shaft 20 having the above configuration, the material of each member is different. Specifically, the first shaft 64, the movable pins 58A and 58B, and the positioning pins 62A and 62B are made of resin, and the second shaft 66 and the biasing members 74 and 76 are made of metal.

The outer second shaft 66 is made of metal, so that a coaxial structure can be configured together with the waveguide structure 12 illustrated in FIGS. 1A and 1B. In the present embodiment, by setting an inner diameter of the second shaft 66 made of metal to ¼ or less of a wavelength of the microwave generated by the microwave generation device 10, incidence of the microwave into the internal space of the second shaft 66 is suppressed. Therefore, the internal space of the second shaft 66 does not affect the supply form of the outer microwave, and a metal member can be incorporated. For example, durability can be improved by making the biasing members 74 and 76 made of metal. Since the first shaft 64, the movable pins 58A and 58B, and the positioning pins 62A and 62B are made of resin, the cost can be reduced.

In the above configuration, the antenna shaft 20 can be made compact by accommodating each member inside the second shaft 66 made of metal, and the antenna drive mechanism 14 can be miniaturized.

FIGS. 10A and 10B are cross-sectional views schematically illustrating a longitudinal cross section of a peripheral configuration of the antenna shaft 20. FIG. 10A illustrates a state (arrow H1) in which the antenna shaft 20 is located at the raised position, and FIG. 10B illustrates a state (arrow H2) in which the antenna shaft 20 is located at the lowered position.

As illustrated in FIGS. 10A and 10B, the motor screw 22 is rotatably accommodated inside the lower cover 38, and the coupling shaft 73 of the motor 24 is inserted and connected through the through hole 50 of the lower cover 38. The screw part 70 provided on the outer periphery of the motor screw 22 and the screw part 68 provided on the inner periphery of the first shaft 64 are screwed together, and the motor shaft 21 and the antenna shaft 20 are integrally rotatable about the rotation axis Ax1.

The ring member 44 including the rotation restriction part 54 is sandwiched between the upper cover 36 and the lower cover 38 in the up-down direction and is positioned in the circumferential direction R. The rotation restriction part 54 is directed toward the outer periphery 23 of the antenna shaft 20 so as to engage with the movable pin 58 of the antenna shaft 20.

The rotation restriction part 54 is provided in two stages at different positions in the axial direction L. The rotation restriction part 54 in the lower stage restricts the rotation of the antenna shaft 20 in the first rotation direction R1 and permits the rotation in the second rotation direction R2. The rotation restriction part 54 in the upper stage restricts the rotation of the antenna shaft 20 in the second rotation direction R2 while permitting the rotation in the first rotation direction R1.

As illustrated in FIG. 10A, in the case that the motor shaft 21 and the antenna shaft 20 rotate in the first rotation direction R1, when the movable pin 58 is located in the lower stage, rotation in the first rotation direction R1 is restricted by engaging with the rotation restriction part 54 in the lower stage. When the motor shaft 21 rotates in the first rotation direction R1 in this state, the antenna shaft 20 screwed into the motor shaft 21 relatively rises along the axial direction L (arrow H1). Since the rotation restriction part 54 in the upper stage does not restrict the rotation of the antenna shaft 20 in the first rotation direction R1, the antenna shaft 20 can continuously rotate in the first rotation direction R1 while the movable pin 58 is located in the upper stage.

As illustrated in FIG. 10B, in the case that the motor shaft 21 and the antenna shaft 20 rotate in the second rotation direction R2, when the movable pin 58 is located in the upper stage, rotation in the second rotation direction R2 is restricted by engaging with the rotation restriction part 54 in the upper stage. When the motor shaft 21 rotates in the second rotation direction R2 in this state, the antenna shaft 20 screwed into the motor shaft 21 relatively descends along the axial direction L (arrow H2). Since the rotation restriction part 54 in the lower stage does not restrict the rotation of the antenna shaft 20 in the second rotation direction R2, the antenna shaft 20 can continuously rotate in the second rotation direction R2 in a state where the movable pin 58 is located in the lower stage.

The control unit 17 switches the rotation directions of the motor shaft 21 and the antenna shaft 20, so that the rotation operation and the up and down operation of the rotating antenna 16 can be executed. Since the rotation operation and the up and down operation of the rotating antenna 16 can be realized by the single motor 24, it is easy to achieve both high functionality and miniaturization of the antenna drive mechanism 14 as compared with a case where the motor for rotation operation and the motor for up and down operation are separately provided.

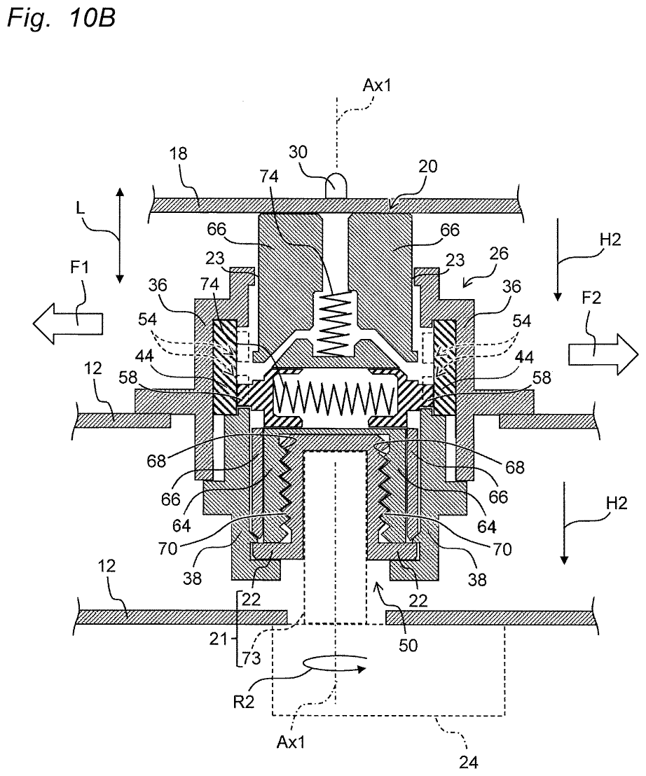

Next, configurations and functions of the rotation restriction part 54 and the ring member 44 including the same will be described with reference to FIG. 11 and subsequent drawings.

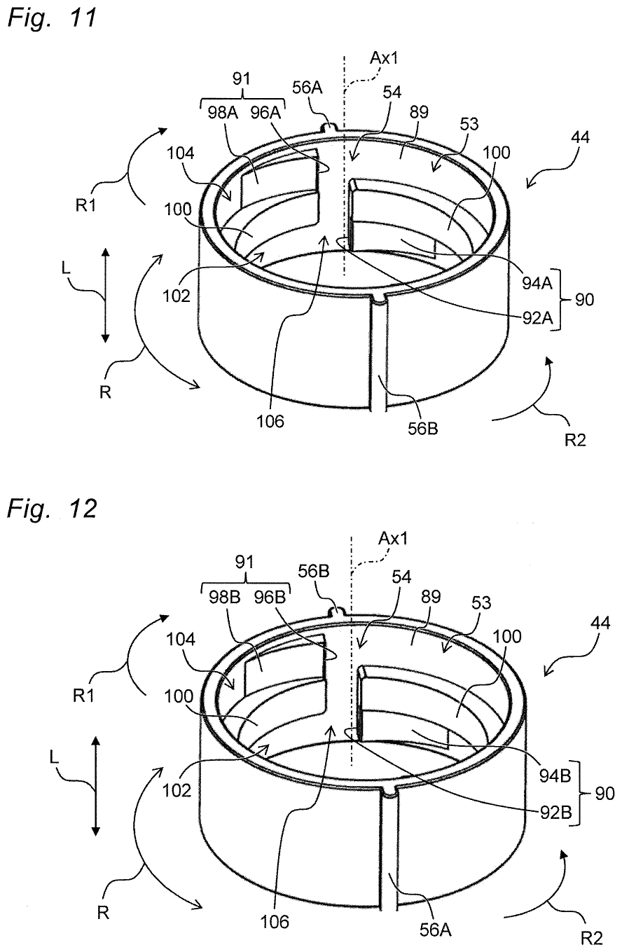

FIGS. 11 and 12 are perspective views of the ring member 44 as viewed from different angles. FIG. 11 is a perspective view as viewed from an angle at which one positioning part 56A of a pair of the positioning parts 56A and 56B included in the ring member 44 is located on the far side, and FIG. 12 is a perspective view as viewed from an angle at which the other positioning part 56B is located on the far side.

As illustrated in FIGS. 11 and 12, the substantially cylindrical ring member 44 includes the rotation restriction part 54 on an inner periphery 89. The rotation restriction part 54 includes a first rotation restriction part 90 located at the lower stage in the axial direction L and a second rotation restriction part 91 located at the upper stage in the axial direction L.

As illustrated in FIG. 11, the first rotation restriction part 90 includes a restriction wall 92A and a slope 94A. As illustrated in FIG. 12, the first rotation restriction part 90 includes a restriction wall 92B and a slope 94B. The first rotation restriction part 90 illustrated in FIGS. 11 and 12 includes a pair of the restriction walls 92A and 92B and a pair of the slopes 94A and 94B.

The restriction walls 92A and 92B are wall parts protruding radially inward from the inner periphery 89 so as to restrict the rotation of the antenna shaft 20 in the first rotation direction R1. Both the restriction walls 92A and 92B face in the second rotation direction R2. A pair of the restriction walls 92A and 92B is provided at positions facing each other, and are in contact with the pair of movable pins 58A and 58B at substantially the same timing. The slopes 94A and 94B are provided at positions adjacent to the restriction walls 92A and 92B, respectively.

The slopes 94A and 94B are inclined walls for assisting the movable pins 58A and 58B to get over the restriction walls 92A and 92B when the antenna shaft 20 rotates in the second rotation direction R2, respectively. Each of the slopes 94A and 94B is smoothly inclined such that the height gradually increases along the second rotation direction R2 in the direction approaching the restriction walls 92A and 92B. By providing the restriction walls 92A and 92B and the slopes 94A and 94B, it is possible to allow the rotation in the second rotation direction R2 while restricting the rotation of the antenna shaft 20 in the first rotation direction R1.

As illustrated in FIGS. 11 and 12, the second rotation restriction part 91 in the upper stage includes a pair of restriction walls 96A and 96B and a pair of slopes 98A and 98B.

The restriction walls 96A and 96B are wall parts protruding radially inward from the inner periphery 89 so as to restrict the rotation of the antenna shaft 20 in the second rotation direction R2. Both the restriction walls 96A and 96B face in the first rotation direction R1. The pair of restriction walls 96A and 96B is provided at positions facing each other, and is in contact with the pair of movable pins 58A and 58B at substantially the same timing. The slopes 98A and 98B are provided at positions adjacent to the restriction walls 96A and 96B, respectively.

The slopes 98A and 98B are inclined walls for assisting the movable pins 58A and 58B to get over the restriction walls 96A and 96B when the antenna shaft 20 rotates in the first rotation direction R1, respectively. Each of the slopes 98A and 98B is smoothly inclined such that the height gradually increases along the first rotation direction R1 in a direction approaching the restriction walls 96A and 96B. By providing the restriction walls 96A and 96B and the slopes 98A and 98B, it is possible to allow the rotation in the first rotation direction R1 while restricting the rotation of the antenna shaft 20 in the second rotation direction R2.

A partition wall part 100 is provided in a middle stage between the lower stage and the upper stage of the inner periphery 89. The partition wall part 100 is a wall part protruding inward from the inner periphery 89 so as to separate the lower stage and the upper stage, and extends along the circumferential direction R. A groove 102 is formed in the lower stage and a groove 104 is formed in the upper stage by the partition wall part 100.

The partition wall part 100 is partially interrupted in the circumferential direction R to form a gap 106. The gap 106 is a gap extending along the axial direction L, and is provided between the first rotation restriction part 90 and the second rotation restriction part 91. The first rotation restriction part 90 and the second rotation restriction part 91 are separated in the circumferential direction R by the gap 106. By providing the gap 106, when the rotation of the movable pins 58A and 58B is restricted by the restriction walls 92A and 92B or the restriction walls 96A and 96B, it is possible to secure a space where the movable pins 58A and 58B and the antenna shaft 20 move up and down along the axial direction L with the rotation of the motor shaft 21.

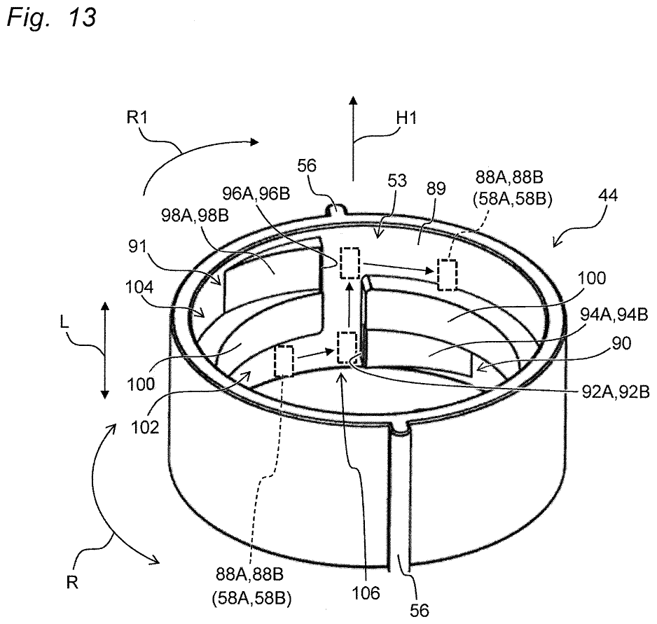

The function and operation of the rotation restriction part 54 having the above configuration will be described with reference to FIGS. 13 to 16.

FIG. 13 is a perspective view for describing an operation in a case where the movable pins 58A and 58B and the antenna shaft 20 rotate in the first rotation direction R1 when the movable pins 58A and 58B are located in the lower stage. In FIGS. 13 and 14 to 16, the engagement parts 88A and 88B of the movable pins 58A and 58B are schematically illustrated by dotted lines.

As illustrated in FIG. 13, when the movable pins 58A and 58B located in the lower stage rotate in the first rotation direction R1, the movable pins come into contact with the restriction walls 92A and 92B protruding so as to face in the second rotation direction R2, and the rotation is restricted. As the motor shaft 21 rotates in the first rotation direction R1 in a state where the rotation of the antenna shaft 20 is restricted, the antenna shaft 20 screwed into the motor shaft 21 relatively rises along the axial direction L (arrow H1). The movable pins 58A and 58B move from the lower stage to the upper stage through the middle stage.

The movable pins 58A and 58B moved to the upper stage rotate in the first rotation direction R1 in the groove 104 of the upper stage.

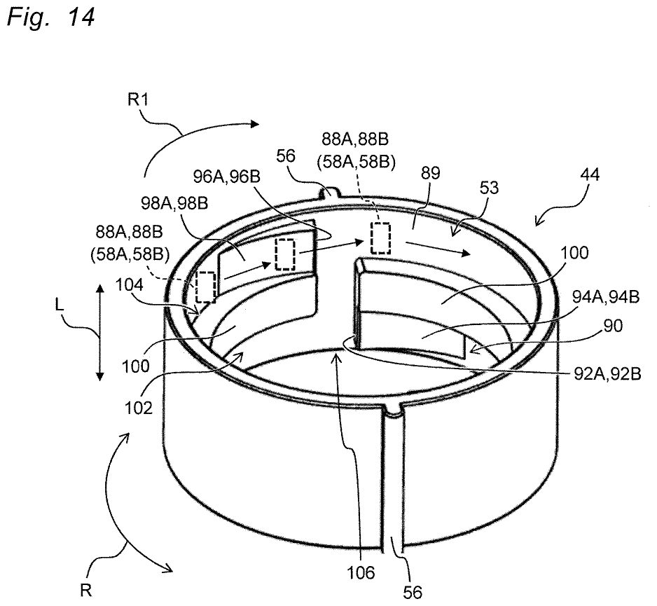

FIG. 14 is a perspective view for describing an operation in a case where the movable pins 58A and 58B and the antenna shaft 20 rotate in the first rotation direction R1 when the movable pins 58A and 58B are located in the upper stage.

As illustrated in FIG. 14, when the movable pins 58A and 58B located in the upper stage rotate in the first rotation direction R1, the movable pins slide along the slopes 98A and 98B whose heights gradually increase along the first rotation direction R1, and get over the restriction walls 96A and 96B. When the movable pins 58A and 58B slide along the slopes 98A and 98B, the biasing member 74 slides while contracting. This enables continuous rotation in the first rotation direction R1.

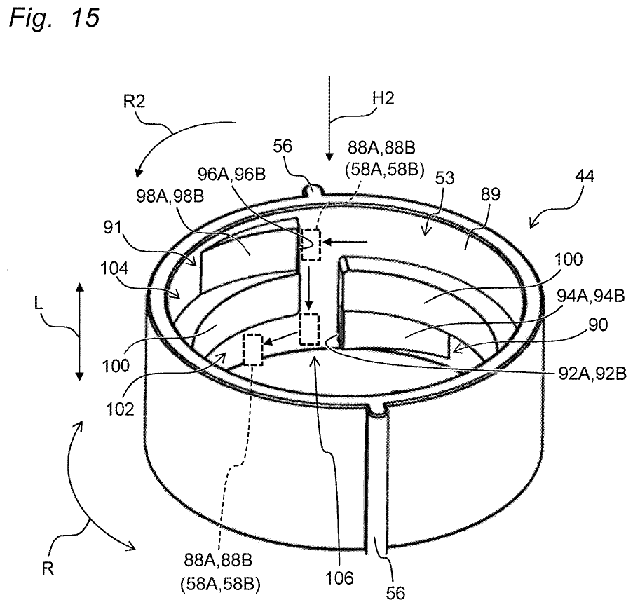

FIG. 15 is a perspective view for describing an operation in a case where the movable pins 58A and 58B and the antenna shaft 20 rotate in the second rotation direction R2 when the movable pins 58A and 58B are located in the upper stage.

As illustrated in FIG. 15, when the movable pins 58A and 58B located in the upper stage rotate in the second rotation direction R2, the movable pins come into contact with the restriction walls 96A and 96B protruding so as to face in the first rotation direction R1, and the rotation is restricted. As the motor shaft 21 rotates in the second rotation direction R2 in a state where the rotation of the antenna shaft 20 is restricted, the antenna shaft 20 screwed to the motor shaft 21 relatively descends along the axial direction L (arrow H2). The movable pins 58A and 58B move from the upper stage to the lower stage through the middle stage.

The movable pins 58A and 58B moved to the lower stage rotate in the second rotation direction R2 in the groove 102 of the lower stage.

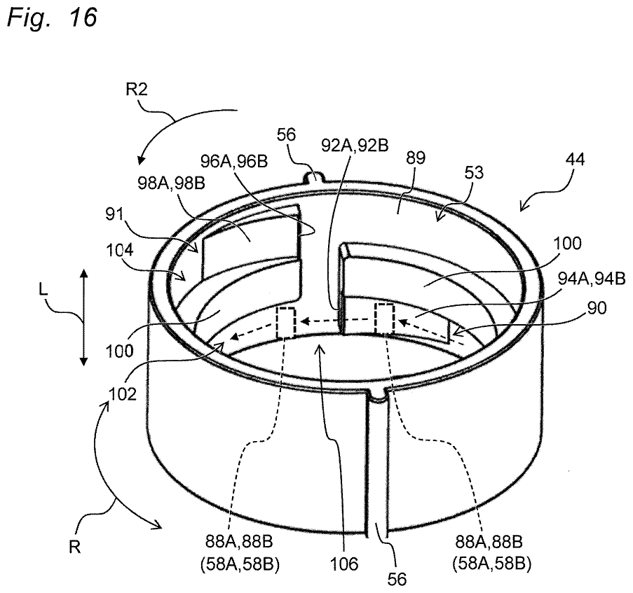

FIG. 16 is a perspective view for describing an operation in a case where the movable pins 58A and 58B and the antenna shaft 20 rotate in the second rotation direction R2 when the movable pins 58A and 58B are located in the lower stage.

As illustrated in FIG. 16, when the movable pins 58A and 58B located at the lower stage rotate in the second rotation direction R2, the movable pins slide along the slopes 94A and 94B whose heights gradually increase along the second rotation direction R2, and get over the restriction walls 92A and 92B. When the movable pins 58A and 58B slide along the slopes 94A and 94B, the biasing member 74 slides while contracting. This enables continuous rotation in the second rotation direction R2.

According to the above configuration, the rotation function and the up and down movement function of the rotating antenna 16 can be realized using the movable pins 58A and 58B of the antenna shaft 20 and the rotation restriction part 54 of the ring member 44. As illustrated in FIGS. 3A and 3B, these operations can be realized by the cover 26 incorporating the ring member 44 and the antenna shaft 20 provided inside the cover 26, which leads to miniaturization of the antenna drive mechanism 14.

As illustrated in FIGS. 7 and 8, the antenna shaft 20 can be miniaturized by disposing the movable pin 58, the positioning pin 62, and the biasing member 74 inside the second shaft 66. Since the second shaft 66 is made of metal, a member made of metal can be disposed in the internal space of the second shaft 66, and the biasing members 74 and 76 can be made of metal to improve durability.

### Operation and Effect

As described above, the antenna drive mechanism 14 of the present embodiment includes: the antenna shaft 20 that supports the rotating antenna 16 for supplying microwaves to the heating chamber 4; the motor shaft 21 that is screwed into the antenna shaft 20, is rotatable integrally with the antenna shaft 20, and is rotationally driven in the first rotation direction RI or the second rotation direction R2; and the first rotation restriction part 90 that selectively restricts rotation of the antenna shaft 20 in the first rotation direction R1, and the second rotation restriction part 91 that selectively restricts rotation of the antenna shaft in the second rotation direction R2, in which in a state where rotation restriction by the first rotation restriction part 90 is exerted, the antenna shaft 20 relatively moves along the axial direction L from a lowered position (first position) where the rotation restriction is exerted to a raised position (second position) where the rotation restriction is released in response to rotation of the motor shaft 21 in the first rotation direction R1, and in a state where rotation restriction by the second rotation restriction part 91 is exerted, the antenna shaft 20 relatively moves along the axial direction L from the raised position where the rotation restriction is exerted to the lowered position where the rotation restriction is released in response to rotation of the motor shaft 21 in the second rotation direction R2.

According to such a configuration, by switching the rotation direction of the motor shaft 21, it is possible to change the position of the antenna shaft 20 in the axial direction L and axially move the rotating antenna 16. As a result, rotational movement and axial movement of the rotating antenna 16 can be realized with a simple configuration, and both high functionality and miniaturization of the antenna drive mechanism 14 can be achieved.

Furthermore, the antenna drive mechanism 14 of the present embodiment further includes the cover 26 provided to face the outer periphery 23 of the antenna shaft 20, in which the first rotation restriction part 90 and the second rotation restriction part 91 are provided on the inner periphery 89 of the cover 26. According to such a configuration, the rotation restriction parts 90 and 91 can be configured using the inner periphery 89 of the cover 26.

Furthermore, the antenna drive mechanism 14 of the present embodiment further includes the waveguide structure 12 that transmits microwaves toward the rotating antenna 16, in which the cover 26 is attached to the waveguide structure 12. According to such a configuration, the cover 26 can be easily provided.

Furthermore, in the antenna drive mechanism 14 of the present embodiment, the cover 26 includes: the ring member 44 (first member) that includes the first rotation restriction part 90 and the second rotation restriction part 91 and constitutes the inner periphery 89; and the upper cover 36 (second member) that is attached to the waveguide structure 12 with the ring member 44 attached inside. According to such a configuration, it is easy to arrange the shapes of the rotation restriction parts 90 and 91 provided in the ring member 44 while attaching the upper cover 36 to the waveguide structure 12.

Furthermore, in the antenna drive mechanism 14 of the present embodiment, the antenna shaft 20 includes the movable pins 58A and 58B (protrusions) that protrude in the lateral direction intersecting the axial direction L, the first rotation restriction part 90 includes the restriction walls 92A and 92B (first restriction walls) that receive the movable pins 58A and 58B in the first rotation direction R1 and the second rotation restriction part 91 includes the restriction walls 96A and 96B (second restriction walls) that receive the movable pins 58A and 58B in the second rotation direction R2, and the restriction walls 92A and 92B and the restriction walls 96A and 96B have different positions in the axial direction L. According to such a configuration, the rotation restriction parts 90 and 91 can be realized with a simple structure.

Furthermore, in the antenna drive mechanism 14 of the present embodiment, the first rotation restriction part 90 is provided adjacent to the restriction walls 92A and 92B (first restriction walls) and includes the slopes 94A and 94B (first slopes) whose heights gradually increase along the second rotation direction R2, and the second rotation restriction part 91 is provided adjacent to the restriction walls 96A and 96B (second restriction walls) and includes the slopes 98A and 98B (second slopes) whose heights gradually increase along the first rotation direction R1. According to such a configuration, the restriction walls 92A and 92B can be configured to restrict the rotation of the antenna shaft 20 in the first rotation direction R1 while permitting the rotation in the second rotation direction R2, and the restriction walls 96A and 96B can be configured to restrict the rotation of the antenna shaft 20 in the second rotation direction R2 while permitting the rotation in the first rotation direction R1.

Furthermore, in the antenna drive mechanism 14 of the present embodiment, the antenna shaft 20 further includes the biasing member 74 (first biasing member) that biases the movable pins 58A and 58B (protrusions) in a protrusion direction. According to such a configuration, by biasing the movable pins 58A and 58B in the protrusion direction, the movable pins 58A and 58B can be more reliably brought into contact with the restriction walls 92A, 92B, 96A, and 96B.

Furthermore, in the antenna drive mechanism 14 of the present embodiment, the movable pins 58A and 58B (protrusions) include the movable pin 58A (first movable pin) that protrudes to one side in the lateral direction and the movable pin 58B (second movable pin) that protrudes to the other side in the lateral direction, and the biasing member 74 (first biasing member) biases the movable pins 58A and 58B in respective protrusion directions. According to such a configuration, cost can be reduced by using the common biasing member 74.

Furthermore, in the antenna drive mechanism 14 of the present embodiment, the antenna shaft 20 includes the first shaft 64 that is screwed into the motor shaft 21 and the second shaft 66 that is disposed outside the first shaft 64 and is movable integrally with the first shaft 64, and the rotating antenna 16 is attached to the second shaft 66. According to such a configuration, shapes and materials of the first shaft 64 and the second shaft 66 can be made different from each other.

Furthermore, the antenna drive mechanism 14 of the present embodiment further includes the biasing member 76 (second biasing member) that generates a biasing force in the axial direction L between the first shaft 64 and the second shaft 66. With such a configuration, when the rotating antenna 16 comes into contact with another object (for example, the bottom wall part 18 of the heating chamber 4), a buffering action can be generated.

Furthermore, in the antenna drive mechanism 14 of the present embodiment, the first shaft 64 is made of resin, and the second shaft 66 is made of metal. According to such a configuration, since the second shaft 66 is made of metal, a coaxial structure for supplying microwaves can be formed, and since the first shaft 64 is made of resin, weight reduction and cost reduction can be realized.

Furthermore, in the antenna drive mechanism 14 of the present embodiment, the first shaft 64 includes the movable pins 58A and 58B (protrusions) that protrude in a lateral direction (radial direction of the antenna shaft 20) intersecting the axial direction L, and the second shaft 66 includes the through hole 82 that allows the movable pins 58A and 58B to pass in the lateral direction. According to such a configuration, the movable pins 58A and 58B to be engaged with the rotation restriction parts 90 and 91 can protrude outward while the antenna shaft 20 is divided into the two shafts 64 and 6.

Furthermore, in the antenna drive mechanism 14 of the present embodiment, the rotating antenna 16 is located away from the bottom wall part 18 (wall part) constituting the heating chamber 4 when the antenna shaft 20 is located at the lowered position (first position), and comes into contact with the bottom wall part 18 when the antenna shaft 20 is located at the raised position (second position). According to such a configuration, when the antenna shaft 20 approaches the heating chamber 4, the rotating antenna 16 is brought into contact with the bottom wall part 18, so that a radiation mode of the microwaves can be stabilized, which leads to uniformity of cooking performance.

Furthermore, in the antenna drive mechanism 14 of the present embodiment, the rotating antenna 16 is in contact with the bottom wall part 18 of the heating chamber 4. According to such a configuration, microwaves can be supplied from below the heating chamber 4.

As described above, the antenna drive mechanism 14 of the present embodiment includes: the antenna shaft 20 that supports the rotating antenna 16 for supplying microwaves to the heating chamber 4; the motor 24 that applies a rotational driving force in the first rotation direction R1 or the second rotation direction R2 to the antenna shaft 20; the rotation restriction part 54 that selectively restricts a rotation operation of the antenna shaft 20 such that when the antenna shaft 20 receives the rotational driving force in the first rotation direction R1, a position in the axial direction L of the antenna shaft 20 is disposed at a lowered position (first position), and when the antenna shaft 20 receives the rotational driving force in the second rotation direction R2, a position in the axial direction L of the antenna shaft 20 is disposed at a raised position (second position) different from the lowered position; and the control unit 17 that controls a rotation direction of the rotational driving force by the motor 24.

According to such a configuration, by switching the rotation direction of the rotational driving force by the motor 24, it is possible to change the position in the axial direction L of the antenna shaft 20 and axially move the rotating antenna 16. As a result, rotational movement and axial movement of the rotating antenna 16 can be realized with a simple configuration, and both high functionality and miniaturization of the antenna drive mechanism 14 can be achieved.

As described above, the microwave heating device 2 according to the present embodiment includes: the antenna drive mechanism 14; the rotating antenna 16 driven by the antenna drive mechanism 14; and the heating chamber 4 to which the rotating antenna 16 supplies microwaves. According to such a configuration, an effect similar to that of the antenna drive mechanism 14 can be obtained.

Although the invention of the present disclosure has been described above with reference to the above-described embodiment, the present disclosure is not limited to the above-described embodiment. For example, in the present embodiment, the case where the movable pins 58A and 58B are a movable type and the restriction walls 92A, 92B, 96A, and 96B are a fixed type has been described, but the invention of the present disclosure is not limited to such a case. For example, the movable pin may be a fixed type, and the restriction wall may be a movable type. In this case, the biasing member 74 that biases the movable pin outward may be omitted, and a biasing member that biases the restriction wall inward may be provided. On the other hand, in the configuration in which the movable pins 58A and 58B are a movable type and biased by the biasing member 74 as in the embodiment, the biasing member 74 made of metal can be accommodated inside the second shaft 66 made of metal, the biasing member 74 having high durability can be used without affecting the microwave supply mode, and the antenna shaft 20 can be miniaturized.

Furthermore, in the above embodiment, a case where the movable pins 58A and 58B, the positioning pins 62A and 62B, the restriction walls 92A and 92B, the slopes 94A and 94B, the restriction walls 96A and 96B, and the slopes 98A and 98B are provided in pairs has been described. However, the invention of the present disclosure is not limited to such a case, and it is sufficient to provide at least one of each.

Although the present disclosure has been fully described in connection with preferred embodiments with reference to the accompanying drawings, various changes and modifications will be apparent to those skilled in the art. Such changes and modifications are to be understood as included within the scope of the invention as defined by the appended claims unless they depart therefrom. Furthermore, combinations of elements and changes in order in each embodiment can be realized without departing from the scope and spirit of the present disclosure.

Note that by appropriately combining arbitrary modification examples among the various modification examples of the above-described embodiment, the effects of the respective modification examples can be achieved.

### INDUSTRIAL APPLICABILITY

The present disclosure is applicable to any antenna drive mechanism that drives a rotating antenna and any microwave heating device including the antenna drive mechanism.

### REFERENCE SIGNS LIST

2 microwave heating device
4 heating chamber
14 antenna drive mechanism
16 rotating antenna
17 control unit
20 antenna shaft
21 motor shaft
24 motor
54 rotation restriction part
90 first rotation restriction part
91 second rotation restriction part
L axial direction
R1 first rotation direction
R2 second rotation direction

1. An antenna drive mechanism comprising:
an antenna shaft that supports a rotating antenna that supplies microwaves to a heating chamber;
a motor shaft that is rotatable integrally with the antenna shaft, and is rotationally driven in a first rotation direction or a second rotation direction; and
a rotation restriction part that selectively restricts rotation of the antenna shaft according to a rotation direction of the motor shaft,
wherein the antenna shaft relatively moves in an axial direction in response to rotation restriction by the rotation restriction part.

2. The antenna drive mechanism according to claim 1, further comprising a cover to face an outer periphery of the antenna shaft,
wherein the rotation restriction part is provided on an inner periphery of the cover.

3. The antenna drive mechanism according to claim 2, further comprising a waveguide structure that transmits microwaves toward the rotating antenna,
wherein the cover is attached to the waveguide structure.

4. The antenna drive mechanism according to claim 3, wherein the cover includes: a first member that includes the rotation restriction part and constitutes the inner periphery; and a second member that is attached to the waveguide structure with the first member attached inside.

5. The antenna drive mechanism according to claim 2, wherein
the antenna shaft includes a protrusion that protrudes in a lateral direction intersecting the axial direction,
the rotation restriction part includes a first restriction wall that receives the protrusion in the first rotation direction and a second restriction wall that receives the protrusion in the second rotation direction, and
the first restriction wall and the second restriction wall have different positions in the axial direction.

6. The antenna drive mechanism according to claim 5, wherein the rotation restriction part includes a first slope whose height gradually increases along the second rotation direction and which is provided adjacent to the first restriction wall, and
a second slope whose height gradually increases along the first rotation direction and which is provided adjacent to the second restriction wall.

7. The antenna drive mechanism according to claim 5, wherein the antenna shaft further includes a first biasing member that biases the protrusion in a protrusion direction.

8. The antenna drive mechanism according to claim 7, wherein the protrusion includes a first protrusion that protrudes to one side in the lateral direction and a second protrusion that protrudes to another side in the lateral direction, and
the first biasing member biases the first protrusion and the second protrusion in respective protrusion directions.

9. The antenna drive mechanism according to claim 1, wherein the antenna shaft includes a first shaft that is screwed into the motor shaft and a second shaft that is disposed outside the first shaft and is movable integrally with the first shaft, and
the rotating antenna is attached to the second shaft.

10. The antenna drive mechanism according to claim 9, further comprising a second biasing member that generates a biasing force in the axial direction between the first shaft and the second shaft.

11. The antenna drive mechanism according to claim 9, wherein the first shaft is made of resin, and the second shaft is made of metal.

12. The antenna drive mechanism according to claim 9, wherein the first shaft includes a protrusion that protrudes in a lateral direction intersecting the axial direction, and the second shaft includes a through hole that allows the protrusion to pass in the lateral direction.

13. The antenna drive mechanism according to claim 1, wherein the rotating antenna is located away from a wall part constituting the heating chamber when the antenna shaft is located at a first position, and comes into contact with the wall part when the antenna shaft is located at a second position.

14. The antenna drive mechanism according to claim 13, wherein the wall part is a bottom wall part of the heating chamber.

15. An antenna drive mechanism comprising:
an antenna shaft that supports a rotating antenna that supplies microwaves to a heating chamber;
a motor that applies a rotational driving force in a first rotation direction or a second rotation direction to the antenna shaft; and
a rotation restriction part that selectively restricts a rotation operation of the antenna shaft such that when the antenna shaft receives the rotational driving force in the first rotation direction, a position in an axial direction of the antenna shaft is disposed at a first position, and when the antenna shaft receives the rotational driving force in the second rotation direction, a position in the axial direction of the antenna shaft is disposed at a second position different from the first position.

16. A microwave heating device comprising: the antenna drive mechanism according to claim 1; the rotating antenna driven by the antenna drive mechanism; and the heating chamber to which the rotating antenna supplies microwaves.

17. The antenna drive mechanism according to claim 1, wherein the rotation restriction part includes a first rotation restriction part that selectively restricts rotation of the antenna shaft in the first rotation direction, and a second rotation restriction part that selectively restricts rotation of the antenna shaft in the second rotation direction,
wherein in a state where rotation restriction by the first rotation restriction part is exerted, the antenna shaft relatively moves along an axial direction from a first position where the rotation restriction is exerted to a second position where the rotation restriction is released, in response to rotation of the motor shaft in the first rotation direction, and
in a state where rotation restriction by the second rotation restriction part is exerted, the antenna shaft relatively moves along the axial direction from the second position where the rotation restriction is exerted to the first position where the rotation restriction is released, in response to rotation of the motor shaft in the second rotation direction.

18. The antenna drive mechanism according to claim 15, further comprising a control unit that controls a rotation direction of the rotational driving force by the motor.
